(19) United States
(12) Patent Application Publication
(10) Pub. No.: US 2022/0154048 A1
(43) Pub. Date: May 19, 2022

(54) THERMALLY EXPANDABLE COMPOSITIONS AND USE THEREOF IN WELDING SEALER TAPES

(71) Applicant: SIKA TECHNOLOGY AG, Baar (CH)

(72) Inventors: Satoshi URAYAMA, Fujisawa-shi (JP); Shunsuke YAMADA, Chigasaki-shi (JP)

(73) Assignee: SIKA TECHNOLOGY AG, Baar (CH)

(21) Appl. No.: 17/439,040

(22) PCT Filed: Mar. 16, 2020
(86) PCT No.: PCT/EP2020/057102

§ 371 Date: Sep. 14, 2021

(30) Foreign Application Priority Data
Mar. 14, 2019 (EP) 19162713.2

(51) Int. Cl. C09J 109/06; C09J 123/22; C09J 11/06; C09J 11/04; C08K 3/04; C08K 3/30

(52) U.S. Cl. CPC C09J 109/06; C09J 123/22; C08K 3/30; C09J 11/04; C08K 3/04; C09J 11/06

(57) ABSTRACT

A thermally expandable composition including at least one solid rubber R, at least on tackifying resin, at least one blowing agent, a vulcanization system, and 0.5-30 wt.-% of fibrous magnesium oxysulphate or carbon fibers or a mixture thereof. Also, a shaped article including a substrate layer composed of the thermally expandable composition, to a method for providing sealing, structural adhesion, baffling, or combination thereof to a structure of a manufactured article, and to use of fibrous magnesium oxysulphate or carbon fibers or a mixture thereof in a thermally expandable composition to improve sag resistance and/or flame resistance properties of said composition.

### TECHNICAL FIELD

The invention relates to synthetic adhesive materials, which are used for bonding of metal surfaces separated by a gap from each other. In particular, the invention relates to adhesive materials, which can be applied to a structure of a mode of transport, such as an automotive vehicle, which assist in or at least do not interfere with manufacturing steps of the mode of transport.

### BACKGROUND OF THE INVENTION

Synthetic adhesive materials are commonly used for reinforcing, baffling, acoustic damping, sealing and the like of structural components of manufactured articles, in particular structural components of transportation vehicles and white goods. It is generally desired that the application of adhesive materials either assists in or at least does not interfere with the processing, formation, or assembly of the manufactured article. For example, it is critical that the synthetic adhesive material, when positioned in a weld location, does not inhibit welding of the components. Furthermore, the synthetic adhesive materials should provide good bonding with metal surfaces, in particular to oiled metal surfaces.

Synthetic adhesive materials are also used in applications, where portions of structures of manufactured articles, such as automotive vehicles, are bonded to each other by spot welding. In some applications, the structures are bonded to each other by welds, which extend through the adhesive material. The adhesive materials used in these applications are also known as “welding sealer tapes” or “weld-through tapes”. In a typical welding application, the adhesive material is applied to a portion of a structure, which is subsequently welded to form a bond with a portion of another structure. The welding of the structures can be conducted using, for example, electric resistance welding. In this case a first electrode is contacted with an outer surface of a first substrate and a second electrode is contacted with an outer surface of a second substrate to be welded with the first substrate. The adhesive material is positioned between the first and second substrates such that at least part of it is located between the electrodes. The electrodes are then moved towards each other resulting in displacement of part of the expandable adhesive material. Simultaneously or after moving of the electrodes, an electrical current is induced to flow between the electrodes thereby forming a weld between a portion of the first and second substrate and through the expandable adhesive material. After the welding, the adhesive material can further be activated to expand or to cure or both. When the structures are part of an automotive vehicle, the activation of the adhesive material is typically conducted at elevated temperature during painting or e-coating (curing) processes.

There are various requirements for expandable adhesive materials suitable for providing welding sealer tapes applied in structures of automotive vehicles. The adhesive material should, for example, provide good bonding to metal surfaces, in particular to aluminum surfaces, and have good corrosion resistance properties. Most importantly, the adhesive material should remain mechanically stable during baking process, i.e. have a good sag resistance properties, as well as high flame resistance properties. The adhesive material should also have an activation temperature in the range of temperatures occurring during painting or e-coating (curing) processes.

The experiments conducted with State-of-the-Art thermally expandable adhesive materials have revealed that providing a welding sealer tape exhibiting the desired properties in terms of bonding to metal surfaces, sag resistance, flame resistance, and volume expansion can only be partially achieved with known compositions.

There thus remains a need for a thermally expandable adhesive material, which can be used for providing welding sealer tapes exhibiting improved properties.

### SUMMARY OF THE INVENTION

The object of the present invention is to provide a thermally expandable composition, which can be used for providing welding sealer tapes with improved properties, in particular improved sag resistance and flame resistance properties.

The subject of the present invention is a thermally expandable composition as defined in claim 1.

It was surprisingly found out that a thermally expandable composition comprising at least one solid rubber R, at least one tackifying resin TR, at least one blowing agent BA and a specific amount of fibrous magnesium oxysulphate can be used for providing welding sealer tapes having improved sag resistance and flame resistance properties.

One of the advantages of the thermally expandable composition of the present invention is that improvements in sag resistance and flame resistance are achieved with compositions having similar or even decreased material costs compared to State-of-the-Art thermally expandable adhesive compositions.

Another advantage of the thermally expandable composition is that the improvements in sag and flame resistance are not achieved on expense of other critical properties, such as volume expansion properties.

Other subjects of the present invention are presented in other independent claims. Preferred aspects of the invention are presented in the dependent claims.

### DETAILED DESCRIPTION OF THE INVENTION

The subject of the present invention is a thermally expandable composition comprising:

a) At least one solid rubber R,

b) At least one tackifying resin TR,

c) At least one blowing agent BA,

d) A vulcanization system VS, and

e) 1-30 wt.-%, preferably 5-25 wt.-%, based on the total weight of the thermally expandable adhesive composition, of fibrous magnesium oxysulphate or carbon fibers or a mixture thereof.

Substance names beginning with “poly” designate substances which formally contain, per molecule, two or more of the functional groups occurring in their names. For instance, a polyol refers to a compound having at least two hydroxyl groups. A polyether refers to a compound having at least two ether groups.

The term “polymer” refers to a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “rubber” refers to any natural, synthetic, or modified high molecular weight polymer or combination of polymers, which is capable of recovering from large deformations, i.e. has elastic properties. Typical rubbers are capable of being elongated or deformed to at least 200% of their original dimension under an externally applied force, and will substantially resume the original dimensions, sustaining only small permanent set (typically no more than about 20%), after the external force is released. In particular, the term “rubber” designates rubbers that have not been chemically crosslinked. The term “chemically crosslinked” is understood to mean that the polymer chains forming the elastomer are inter-connected by a plurality of covalent bonds, which are mechanically and thermally stable.

The term “molecular weight” refers to the molar mass (g/mol) of a molecule or a part of a molecule, also referred to as “moiety”. The term “average molecular weight” refers to number average molecular weight (Mn) of an oligomeric or polymeric mixture of molecules or moieties. The molecular weight may be determined by gel permeation chromatography.

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using an applied frequency of 1 Hz and a strain level of 0.1%.

The term “softening point” refers to a temperature at which a compound softens in a rubber-like state, or a temperature at which the crystalline portion within the compound melts. The softening point can be determined by ring and ball measurement conducted according to DIN EN 1238 standard.

The “amount or content of at least one component X” in a composition, for example “the amount of the at least one thermoplastic polymer” refers to the sum of the individual amounts of all thermoplastic polymers contained in the composition. For example, in case the composition comprises 20 wt.-% of at least one thermoplastic polymer, the sum of the amounts of all thermoplastic polymers contained in the composition equals 20 wt.-%.

The term “room temperature” designates a temperature of 23° C.

The thermally expandable composition comprises 1-30 wt.-%, preferably 5-25 wt.-%, more preferably 7.5-25 wt.-%, even more preferably 10-25 wt.-%, most preferably 10-20 wt.-%, based on the total weight of the thermally expandable composition, of fibrous magnesium oxysulphate or carbon fibers or a mixture thereof, preferably of fibrous magnesium oxysulphate or a mixture of fibrous magnesium oxysulphate and carbon fibers, more preferably of fibrous magnesium oxysulphate.

Preferably, the fibrous magnesium oxysulphate comprises at least one magnesium oxysulphate compound having a general formula of xMg(OH)₂.yMgSO₄.zH₂O, wherein the x, y, and z have values in the range of 1 to 10. The values for x, y, and z include both integers and fractions due to the fact that the stoichiometry of the magnesium oxysulfate compound may result in, for example, magnesium hydroxide units that are “shared” by magnesium sulfate units and/or waters of hydration.

According to one or more embodiments, the fibrous magnesium oxysulphate comprises at least one compound selected from the group consisting of 5Mg(OH)₂.MgSO₄.3H₂O, 5Mg(OH)₂.MgSO₄.2H₂O, 3Mg(OH)₂.MgSO₄.8H₂O, Mg(OH)₂.MgSO₄.5H₂O, Mg(OH)₂.2MgSO₄.3H₂O, 4.34Mg(OH)₂.MgSO₄.2H₂O, and Mg(OH)₂.2MgSO₄.2H₂O. According to one or more embodiments, the fibrous magnesium oxysulphate comprises 5Mg(OH)₂.MgSO₄.3H₂O.

Magnesium oxysulphate is generally available in the form of spheres, plates, rods, or whiskers having various dimensions. According to one or more embodiments, the microcrystalline structure of the fibrous magnesium oxysulphate is a whisker. The term “whisker” refers in the present document to monocrystalline or polycrystalline discontinuous fibers typically having an average thickness of up to a few micrometers and an average length that is typically 10 to 100 times the thickness of the fibers. Magnesium oxysulphate whiskers (MOSw) have been found out to provide improved results in terms of sag resistance and flame resistance in the thermally expandable composition compared to other forms of magnesium oxysulphate. According to one or more embodiments, the fibrous magnesium oxysulphate has been surface treated, preferably by a silane coupling agent.

According to one or more embodiments, the particles of the fibrous magnesium oxysulphate have an average aspect ratio of at least 5, preferably at least 10, more preferably at least 15, even more preferably at least 20. The term “aspect ratio” refers in the present document to the value obtained by dividing the length of a particle, i.e. the particle's largest dimension, by the arithmetic mean of the two remaining dimensions of the same particle, i.e. the width and height/thickness. The term “average aspect ratio” refers in the present document to the arithmetic average of the individual aspect ratios of the particles within a sample or collection or a statistically significant and representative random sample drawn from such a sample or collection. The aspect ratio and average aspect ratio of the particles can be determined by using any suitable measurement technique. For example, the average aspect ratio can be determined by measuring the dimensions of individual particles using, for example, a microscope, for example a scanning electron microscope, and calculating the aspect ratio from the measured dimensions as described above.

According to one or more embodiments, the fibrous magnesium oxysulphate has an average particle diameter of not more than 10 μm, preferably not more than 5 μm, more preferably not more than 3.5 μm, even more preferably not more than 3.0 μm, most preferably not more than 2.5 μm and/or an average particle length of not more than 100 μm, preferably not more than 75 μm, more preferably not more than 50 μm, even more preferably not more than 40 μm, most preferably not more than 35 μm. The terms “average particle diameter” and “average particle length” refer in the present document to an arithmetic average of individual dimensions of the particles within a sample or collection or a statistically significant and representative random sample drawn from such a sample or collection. The average particle diameter and length can be determined by using any suitable measurement technique. For example, the diameter and length of individual particles in a sample can be first determined using, for example, a microscope, for example a scanning electron microscope and the average particle diameter and length are then calculated from the measured dimensions. Preferably, the particle diameter is measured as a Krumbein diameter or a maximum diameter along a fixed direction of the particle.

According to one or more embodiments, the fibrous magnesium oxysulphate has an average particle diameter in the range of 0.1-5.0 μm, preferably 0.15-3.5 μm, more preferably 0.25-3.0 μm, even more preferably 0.35-2.5 μm and/or an average particle length in the range of 2.5-75 μm, preferably 5-50 μm, more preferably 5-40 μm, even more preferably 10-35 μm.

The carbon fibers that can be used instead or in addition to the fibrous magnesium oxysulphate, are preferably milled carbon fibers. According to one or more embodiments, the carbon fibers have an average fiber diameter of not more than 50 μm, preferably not more than 35 μm, more preferably not more than 25 μm, even more preferably not more than 20 μm, most preferably not more than 15 μm and/or an average fiber length of not more than 500 μm, preferably not more than 350 μm, more preferably not more than 250 μm, even more preferably not more than 200 μm, such as not more than 150 μm.

According to one or more embodiments, the carbon fibers have an average fiber diameter in the range of 1-50 μm, preferably 2.5-35 μm, more preferably 2.5-25 μm, even more preferably 3.5-15 μm and/or an average particle length in the range of 15-500 μm, preferably 25-350 μm, more preferably 25-250 μm, even more preferably 50-150 μm.

The thermally expandable composition further comprises at least one solid rubber R. The term “solid rubber” designates in the present document rubbers that are solid at a temperature of 25° C. The amount of the solid rubber R in the thermally expandable composition is not subject to any particular restrictions. It is however preferred that the at least one solid rubber R is present in the thermally expandable composition in an amount of at least 2.5 wt.-%, more preferably at least 5 wt.-%, based on the total weight of the thermally expandable composition.

According to one or more embodiments, the at least one solid rubber R comprises 5-35 wt.-%, preferably 7.5-30 wt.-%, more preferably 10-25 wt.-%, even more preferably 12.5-20 wt.-% of the total weight of the thermally expandable composition.

The at least one solid rubber R is preferably selected from the group consisting of butyl rubber, halogenated butyl rubber, styrene-butadiene rubber (SBR), ethylene-propylene rubber (EPR), ethylene-propylene diene monomer rubber (EPDM), natural rubber, polychloroprene rubber, cis-1,4-polyisoprene, polybutadiene rubber, isoprene-butadiene rubber, styrene-isoprene-butadiene rubber, nitrile rubber, nitrile-butadiene rubber, and acrylonitrile rubber.

According to one or more embodiments, the at least one solid rubber R is selected from the group consisting of butyl rubber, halogenated butyl rubber, styrene-butadiene rubber (SBR), ethylene-propylene rubber (EPR), ethylene-propylene diene monomer rubber (EPDM), natural rubber, cis-1,4-polyisoprene, and polybutadiene rubber.

Preferred solid rubbers R have an average molecular weight (Mn) of at least 100′000 g/mol, such as at least 125′000 g/mol.

According to one or more embodiments, the at least one solid rubber R comprises at least one solid styrene-butadiene rubber R1.

Preferably, the at least one solid styrene-butadiene rubber R1 is an emulsion-polymerized styrene-butadiene rubber. These can be divided into two types, cold rubber and hot rubber depending on the emulsion polymerization temperature, but hot rubbers (hot type) are preferred.

Preferably, the at least one solid styrene-butadiene rubber R1 has a styrene content of 1-60 wt.-%, more preferably 2-50 wt.-%, even more preferably 10-40 wt.-%, such as 15-40 wt.-%, most preferably 20-35 wt.-%.

Preferably, the at least one solid styrene-butadiene rubber R1 has a Mooney viscosity (ML 1+4 at 100° C.) of 25-150 MU (Mooney units), more preferably 30-100 MU, even more preferably 35-80 MU.

Preferred solid styrene-butadiene rubbers R1 include pre-crosslinked styrene-butadiene elastomers, which are commercially available, for example, under the trade name of Petroflex® SBR 1009A, 1009S and 1018 elastomers, manufactured by Petroflex/Lanxess, using either rosin or fatty acids soaps as emulsifier and coagulated by the salt-acid method, and SBR 1009, 1009A, 1502, and 4503 elastomers, manufactured by Lion Elastomers, by hot emulsion polymerization with divinylbenzene.

According to one or more embodiments, the at least one solid rubber R comprises at least one solid butyl rubber R2.

The term “butyl rubber” designates in the present document a polymer derived from a monomer mixture containing a major portion of a C₄ to C₇ monoolefin monomer, preferably an isoolefin monomer and a minor portion, such as not more than 30 wt.-%, of a C₄ to C₁₄ multiolefin monomer, preferably a conjugated diolefin.

The preferred C₄ to C₇ monoolefin monomer may be selected from the group consisting of isobutylene, 2-methyl-1-butene, 3-methyl-1-butene, 2-methyl-2-butene, 4-methyl-1-pentene, and mixtures thereof.

The preferred C₄ to C₁₄ multiolefin comprises a C₄ to C₁₀ conjugated diolefin. The preferred C₄ to C₁₀ conjugated diolefin may be selected from the group comprising isoprene, butadiene, 2,4-dimethylbutadiene, piperyline, 3-methyl-1,3-pentadiene, 2,4-hexadiene, 2-neopentyl-1,3-butadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof.

Preferably, the at least one solid butyl rubber R2 is derived from a monomer mixture containing from about 80 wt.-% to about 99 wt.-% of a C₄ to C₇ monoolefin monomer and from about 1.0 wt.-% to about 20 wt.-% of a C₄ to C₁₄ multiolefin monomer. More preferably, the monomer mixture contains from about 85 wt.-% to about 99 wt.-% of a C₄ to C₇ monoolefin monomer and from about 1.0 wt.-% to about 10 wt.-% of a C₄ to C₁₄ multiolefin monomer. Most preferably, the monomer mixture contains from about 95 wt.-% to about 99 wt.-% of a Cato C₇ monoolefin monomer and from about 1.0 wt.-% to about 5.0 wt.-% of a C₄ to C₁₄ multiolefin monomer.

The most preferred at least one solid butyl rubber R2 is derived from a monomer mixture comprising from about 97 wt.-% to about 99.5 wt.-% of isobutylene and from about 0.5 wt.-% to about 3 wt.-% of isoprene.

It is furthermore possible to include an optional third monomer to produce a butyl terpolymer. For example, it is possible to include a styrenic monomer in the monomer mixture, preferably in an amount up to about 15 wt.-% of the monomer mixture. The preferred styrenic monomer may be selected from the group comprising p-methylstyrene, styrene, α-methylstyrene, p-chlorostyrene, p-methoxystyrene, indene, indene derivatives and mixtures thereof. The most preferred styrenic monomer may be selected from the group comprising styrene, p-methylstyrene and mixtures thereof. Other suitable copolymerizable termonomers will be apparent to those of skill in the art.

Preferably, the at least one solid butyl rubber R2 has a Mooney Viscosity (ML 1+8 at 125° C.) of not more than 125 MU (Mooney units), more preferably not more than 100 MU, even more preferably not more than 85 MU. The Mooney viscosity refers to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646 standard.

According to one or more embodiments, the at least one solid butyl rubber R2 is a halogenated butyl rubber, preferably a chlorinated butyl rubber or a brominated butyl rubber, especially preferred a brominated butyl rubber.

Preferred halogenated butyl rubbers comprise a halogen in an amount of at least 0.1 wt.-%, in particular 0.1-10.0 wt.-%, preferably 0.1-8.0 wt.-%, more preferably 0.5-8.0 wt.-%, even more preferably 0.5-4.0 wt.-%, most preferably 1.5-3.0 wt.-%, based on the weight of the butyl rubber.

According to one or more embodiments, the at least one solid butyl rubber R2 is a mixture of a solid halogenated butyl rubber and a solid non-halogenated butyl rubber, wherein the solid halogenated butyl rubber is preferably a brominated butyl rubber. Preferably, in these embodiments the weight ratio of the amount of the solid halogenated butyl rubber and the amount of the solid non-halogenated butyl rubber is in the range of 20-0.1, more preferably 15-0.5, even more preferably 12.5-1, most preferably 10-1.

According to one or more embodiments, the at least one solid rubber R comprises at least one solid polybutadiene rubber R3.

The term “polybutadiene rubber” designates in the present document a polymer obtained from the polymerization of the 1,3-butadiene monomer. A preferred at least one solid polybutadiene rubber R3 has a 1,4 cis-bond content of at least 40 wt.-%, more preferably greater than 80 wt.-%, even more preferably greater than 95 wt.-%.

Preferably, the at least one solid polybutadiene rubber R3 has a Mooney Viscosity (ML 1+4 at 100° C.) of 20-100 MU (Mooney units), more preferably 25-80 MU, even more preferably 30-60 MU.

According to one or more embodiments, the at least one solid rubber R is selected from the group consisting of a solid styrene-butadiene rubber R1, a solid butyl rubber R2, and a solid polybutadiene rubber R3.

According to one or more embodiments, the at least one solid rubber R is composed of at least one solid styrene-butadiene rubber R1.

According to one or more embodiments, the at least one solid rubber R is composed of at least one solid butyl rubber R2, preferably of a solid halogenated butyl rubber or a mixture of a solid halogenated butyl rubber and a solid non-halogenated butyl rubber, wherein the solid halogenated butyl rubber is preferably a brominated butyl rubber.

According to one or more embodiments, the at least one solid rubber R is composed of at least one solid polybutadiene rubber R3.

According to one or more preferred embodiments, the at least one solid rubber R comprises at least one solid styrene-butadiene rubber R1 and at least one solid butyl rubber R2, wherein the ratio of the amount of the at least one solid styrene-butadiene rubber R1 to the amount of the at least one solid butyl rubber R2 is preferably in the range of 1:30 to 30:1, more preferably 1:1 to 30:1, even more preferably 5:1 to 25:1 and wherein the at least one solid butyl rubber is preferably a non-halogenated solid butyl rubber.

The thermally expandable composition further comprises at least one tackifying resin TR.

The term “tackifying resin” designates in the present document resins that in general enhance the adhesion and/or tackiness of a composition. The term “tackiness” refers in the present document to the property of a substance of being sticky or adhesive by simple contact, which can be measured, for example, as a loop tack. Preferred tackifying resins are tackifying at a temperature of 25° C. Such tackifying resins TR lead to good adhesion on metal substrates, especially oiled metal substrates, both before and after foaming of the thermally expandable composition.

Tackifying resins typically have a relatively low average molecular weight (Mn), such as not more than 5′000 g/mol, in particular not more than 3′500 g/mol, preferably not more than 2′500 g/mol. Preferably, the at least one tackifying resin TR has a softening point measured by a Ring and Ball method according to DIN EN 1238 in the range of 50-180° C., more preferably 65-160° C., even more preferably 70-150° C., most preferably 75-150° C. and/or an average molecular weight (Mn) in the range of 250-5′000 g/mol, more preferably 300-3′500 g/mol, even more preferably 500-3′000 g/mol.

According to one or more embodiments, the at least one tackifying resin TR comprises 2.5-30 wt.-%, preferably 5-25 wt.-%, more preferably 7.5-20 wt.-%, even more preferably 10-20 wt.-% of the total weight of the thermally expandable composition.

Suitable resins to be used as the at least one tackifying resin TR include synthetic resins, natural resins, and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable rosin esters can be obtained, for example, from reactions of rosins and polyhydric alcohol or polyol such as pentaerythritol, glycerol, dipentaerythritol, tripentaerythritol, trimethylol ethane, trimethylol propane, ethylene glycol, polyethylene glycol, 1,3-propanediol, 1,4-butanediol, 1,5-pentanediol, 1,6-hexanediol, trimethylene glycol, propylene glycol, neopentyl glycol, in the presence of acid or base catalyst.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” designates in the present document compounds obtained from the controlled chemical reactions such as polyaddition or polycondensation between well-defined reactants that do not themselves have the characteristic of resins. Monomers that may be polymerized to synthesize the synthetic resins may include aliphatic monomer, cycloaliphatic monomer, aromatic monomer, or mixtures thereof. Suitable aliphatic monomers may include C₄, C₅, and C₆ paraffins, olefins, and conjugated diolefins. Examples of aliphatic monomers or cycloaliphatic monomers include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, and dicyclopentadiene. Examples of aromatic monomer include C₈, C₉, and C₁₀ aromatic monomers. Typical aromatic monomers include, styrene, alphamethyl styrene, vinyl toluene, methoxy styrene, tertiary butyl styrene, chlorostyrene, coumarone, and indene monomers including indene, and methyl indene, and combinations thereof.

Suitable synthetic resins include, for example, hydrocarbon resins, coumarone-indene resins, polyindene resins, polystyrene resins, vinyl toluene-alphamethyl styrene copolymer resins, and alphamethyl styrene resins.

The term “hydrocarbon resin” designates in the present document synthetic resins made by polymerizing mixtures of unsaturated monomers obtained from petroleum based feedstocks, such as by-products of cracking of natural gas liquids, gas oil, or petroleum naphthas. These types of hydrocarbon resins are also known as “petroleum resins” or as “petroleum hydrocarbon resins”. The hydrocarbon resins include also pure monomer aromatic resins, which are prepared by polymerizing aromatic monomer feedstocks that have been purified to eliminate color causing contaminants and to precisely control the composition of the product.

Examples of suitable hydrocarbon resins include C₅ aliphatic resins, mixed C₅/C₉ aliphatic/aromatic resins, aromatic modified C₅ aliphatic resins, cycloaliphatic resins, mixed C₅ aliphatic/cycloaliphatic resins, mixed C₉ aromatic/cycloaliphatic resins, mixed C₅ aliphatic/cycloaliphatic/C₉ aromatic resins, aromatic modified cycloaliphatic resins, C₉ aromatic resins, as well hydrogenated versions of the aforementioned resins. The notations “C₅” and “C₉” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Examples of suitable commercially available hydrocarbon resins include, for example, Wingtack® 86, Wingtack® 95, Wingtack® 98 (from Cray Valley); Wingtack® Plus, Wingtack® Extra, Wingtack® ET, Wingtack® STS, and Wingtack® 86 (from Cray Valley); Escorez® 1000-series, Escorez® 2000-series, Escorez® 5300-series, Escorez® 5400-series, and Escorez® 5600-series (all from Exxon Mobile Chemical);

According to one or more embodiments, the at least one tackifying resin TR comprises a hydrocarbon resin, preferably a C₅ aliphatic hydrocarbon resin TR1, preferably having a softening point measured by a Ring and Ball method according to DIN EN 1238 of not more than 160° C., more preferably not more than 150° C., even more preferably not more than 140° C.

According to one or more embodiments, the at least one tackifying resin TR comprises a mixed C₅/C₉ aliphatic/aromatic hydrocarbon resin TR2, preferably having a softening point measured by a Ring and Ball method according to DIN EN 1238 of not more than 160° C., more preferably not more than 150° C., even more preferably not more than 140° C.

According to one or more embodiments, the at least one tackifying resin TR comprises both a C₅ aliphatic hydrocarbon resin TR1 and mixed C₅/C₉ aliphatic/aromatic hydrocarbon resin TR2, wherein the weight ratio of the amount of the hydrocarbon resin TR1 to the amount of the hydrocarbon resin TR2 is preferably in the range of 0.1-3, preferably 0.5-2.5, more preferably 0.5-2.

The thermally expandable composition further comprises at least one blowing agent BA.

A suitable blowing agent may be a chemical or physical blowing agent. Chemical blowing agents are organic or inorganic compounds that decompose under influence of, for example temperature or humidity, while at least one of the formed decomposition products is a gas. Physical blowing agents include, but are not limited to, compounds that become gaseous at a certain temperature. Preferably, the at least one blowing agent BA is a chemical blowing agent.

Suitable chemical blowing agents include, but are not limited to, azo compounds, hydrazides, nitroso compounds, carbamates, carbazides, bicarbonates, polycarboxylic acids, and salts of polycarboxylic acids.

According to one or more embodiments, the at least one blowing agent BA is selected from the group consisting of azodicarbonamide, azoisobutytronitrile, azocyclohexyl nitrile, dinitrosopentamethylene tetramine, azodiamino benzene, benzene-1,3-sulfonyl hydrazide, calcium azide, 4,4″-diphenyldisulphonyl azide, p-toluenesulphonyl hydrazide, p-toluenesulphonyl semicarbazide, 4,4′-oxybis(benzenesulphonylhydrazide), trihydrazino triazine, and N,N′-dimethyl-N,N′-dinitrosoterephthalamide, and combinations thereof.

Also suitable as chemical blowing agents are dual chemical systems, such as acid/base systems that generate gases upon reaction, for example a combination of sodium hydrogen carbonate and citric acid. According to one or more embodiments, the at least one blowing agent BA comprises a mixture of bicarbonate and polycarboxylic acids and/or salts thereof, preferably a mixture of sodium bicarbonate and citric acid and/or citrate.

Suitable physical blowing agents further include expandable microspheres, consisting of a thermoplastic shell filled with thermally expandable fluids or gases. Suitable expandable microspheres are commercially available, for example, under the trademark of Expancel® microspheres (from AkzoNobel).

According to one or more embodiments, the at least one blowing agent BA comprises or consists of at least one blowing agent selected from the group consisting of azodicarbonamide, expandable microspheres, and 4,4″-oxybis(benzenesulphonylhydrazide).

According to one or more embodiments, the at least one blowing agent BA comprises or consists of azodicarbonamide.

According to one or more embodiments, the at least one blowing agent BA comprises 0.1-5 wt.-%, preferably 0.25-3.5 wt.-%, more preferably 0.5-3 wt.-%, even more preferably 1-3 wt.-% of the total weight of the thermally expandable composition. Such an amount, especially if the blowing agent is azodicarbonamide, provides the advantage of uniform/even expansion behaviour.

The thermally expandable composition may also contain an activator, catalyst, or accelerator for the at least one blowing agent BA. Examples of compounds suitable for this purpose include zinc compounds, such as zinc oxide, zinc stearate, zinc bis(p-toluenesulphinate), and zinc bis(benzenesulphinate), magnesium oxide, and (modified) urea compounds. Although some of the compounds used in the present invention are characterized as useful for specific functions, it should be understood that the use of these compounds is not limited to their typical functions. For example, some of the compounds presented suitable for use as an accelerator for a curing agent may also function as an activator for a blowing agent or vice versa. This is in particular true for zinc compounds, such as zinc oxide, which have been found to have a dual function as an accelerator in the vulcanization system VS and as an activator for the at least one blowing agent BA.

According to one or more embodiments, the thermally expandable composition comprises at least one activator for the blowing agent BA, preferably an urea compound, wherein said activator preferably comprises 0.1-4 wt.-%, more preferably 0.25-3.5 wt.-%, even more preferably 0.5-3 wt.-% of the total weight of the thermally expandable composition

The thermally expandable composition further comprises a vulcanization system VS.

A large number of vulcanization systems based on elementary sulfur as well as vulcanization systems not containing elementary sulfur are suitable.

In case a vulcanization system based on elementary sulfur is used, the system preferably contains pulverulent sulfur, more preferably at least one sulfur compound selected from the group consisting of powdered sulfur, precipitated sulfur, high dispersion sulfur, surface-treated sulfur, and insoluble sulfur.

Preferred vulcanization systems based on elementary sulfur comprise 1-15 wt.-%, more preferably 5-10 wt.-% of pulverulent sulfur, preferably at least one sulfur compound selected from the group consisting of powdered sulfur, precipitated sulfur, high dispersion sulfur, surface-treated sulfur, and insoluble sulfur, based on the total weight of the vulcanization system.

According to one or more embodiments, the vulcanization system VS is a vulcanization system without elementary sulfur.

Preferred vulcanization systems without elementary sulfur comprise at least one vulcanization agent and optionally at least one organic vulcanization accelerator and/or at least one inorganic vulcanization accelerator.

Suitable vulcanization agents for vulcanization systems without elementary sulfur include, for example, organic peroxides, phenolic resins, bisazidoformates, polyfunctional amines, para-quinone dioxime, para-benzoquinone dioxime, para-quinone dioxime dibenzoate, p-nitrosobenzene, dinitrosobenzene, thiuram compounds, bismaleimides, dithiols, zinc oxide as well as vulcanization systems crosslinked with (blocked) diisocyanates.

Suitable organic vulcanization accelerators to be used in the vulcanization systems without elementary sulfur include thiocarbamates, dithiocarbamates (in the form of their ammonium or metal salts), xanthogenates, thiuram compounds (monosulfides and disulfides), thiazole compounds, aldehyde-amine accelerators, for example hexamethylenetetramine, and guanidine accelerators.

Suitable inorganic vulcanization accelerators to be used in the vulcanization systems without elementary sulfur include, for example, zinc compounds, in particular zinc salts of fatty acids, basic zinc carbonates, and zinc oxide.

According to one or more embodiments, the vulcanization system VS is a vulcanization system without elementary sulfur containing at least one vulcanization agent selected from the group consisting of para-quinone dioxime, para-benzoquinone dioxime, para-quinone dioxime dibenzoate, p-nitrosobenzene, dinitrosobenzene, and thiuram compounds, preferably from the group consisting of para-quinone dioxime, para-benzoquinone dioxime, para-quinone dioxime dibenzoate, tetramethyl thiuram disulfide (TMTD), and tetrabenzylthiuram disulfide (TBzTD), and preferably further containing at least one organic vulcanization accelerator and/or at least one an inorganic vulcanization accelerator.

Preferably, the at least one organic vulcanization accelerator is selected from the group consisting of cyclohexylbenzothiazole sulfonamide, mercaptobenzothiazole sulfide (MBTS), diphenyl guanidine, and zinc dimethyldithiocarbamate.

Preferably, the at least one inorganic vulcanization accelerator is selected from the group consisting of zinc salts of fatty acids, basic zinc carbonates, and zinc oxide, more preferably zinc oxide.

Preferably, the vulcanization system VS without elementary sulfur comprises 1-15 wt.-%, more preferably 1-12.5 wt.-%, even more preferably 2-10 wt.-%, most preferably 3.5-10 wt.-% of the total weight of the thermally expandable composition.

According to one or more preferred embodiments, the vulcanization system VS without elementary sulfur comprises 10-40 wt.-%, preferably 20-35 wt.-% of at least one vulcanization agent, preferably selected from the group consisting of para-quinone dioxime, para-benzoquinone dioxime, para-quinone dioxime dibenzoate, tetramethyl thiuram disulfide (TMTD), and tetrabenzylthiuram disulfide (TBzTD), and 10-40 wt.-%, preferably 20-35 wt.-% of at least one organic vulcanization accelerator, preferably selected from the group consisting of cyclohexylbenzothiazole sulfonamide, mercaptobenzothiazole sulfide (MBTS), diphenyl guanidine, and zinc dimethyldithiocarbamate and/or 10-40 wt.-%, preferably 20-35 wt.-% of at least one inorganic vulcanization accelerator, preferably selected from the group consisting of zinc salts of fatty acids, basic zinc carbonates, and zinc oxide, more preferably zinc oxide, wherein all the proportions are based on total weight of the vulcanization system VS.

According to one or more embodiments, the thermally expandable composition further comprises at least one plasticizer PL, preferably selected from the group consisting of process oils and at 25° C. liquid polyolefin resins.

Preferably, the at least one plasticizer PL, if used, is present in the thermally expandable composition in an amount of 2.5-25 wt.-%, more preferably 5-20 wt.-%, even more preferably 5-15 wt.-%, based on the total weight of the thermally expandable composition.

Suitable process oils include mineral oils and synthetic oils. The term “mineral oil” refers in the present disclosure hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In particular, the term “mineral” refers in the present disclosure to refined mineral oils, which can be also characterized as Group I-III base oils according the classification of the American Petroleum Institute (API). Suitable mineral oils to be used as the at least one plasticizer PL include paraffinic, naphthenic, and aromatic mineral oils. Particularly suitable mineral oils include paraffinic and naphtenic oils containing relatively low amounts of aromatic moieties, such as not more than 25 wt.-%, preferably not more than 15 wt.-%, based on the total weight of the mineral oil.

The term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching. Particularly suitable synthetic oils include those obtained from so-called Gas-To-Liquids processes.

According to one or more embodiments, the at least one plasticizer PL comprises a process oil PL1, preferably selected from the group consisting of naphtenic and paraffinic mineral oils.

Suitable at 25° C. liquid polyolefin resins include, for example, polybutene and polyisobutylene (PIB), in particular low molecular weight polybutene and low molecular weight polyisobutylene. The term “polybutene” refers in the present document to low molecular weight olefin oligomers comprising isobutylene and/or 1-butene and/or 2-butene. The ratio of the C₄-olefin isomers can vary by manufacturer and by grade. When the C₄-olefin is exclusively 1-butene, the material is referred to as “poly-n-butene” or “PNB”. The term “polyisobutylene” refers in the present document to polyolefins and olefin oligomers of isobutylene. Typically, the polybutene and polyisobutylene have an average molecular weight (Mn) of less than 15′000 g/mol, preferably less than 5′000 g/mol, more preferably less than 3,500 g/mol.

Suitable commercially available liquid polybutenes include, for example, Indopol® H- and L-series from Ineos Oligomers, Infineum® C-series and Parapol® series from Infineum, and PB-series from Daelim. Suitable commercially available liquid polyisobutylenes (PIB) include, for example, Glissopal® V-series from BASF and Dynapak®-series from Univar GmbH, Germany.

According to one or more embodiments, the at least one plasticizer PL comprises a at 25° C. liquid polyolefin resin PL2, preferably selected from the group consisting of low molecular weight polybutene and low molecular weight polyisobutylene, preferably having an average molecular weight (Mn) of less than 10′000 g/mol, more preferably less than 5′000 g/mol, even more preferably less than 3,500 g/mol.

According to one or more embodiments, the thermally expandable composition further comprises at least one particulate filler F, preferably selected from the group consisting of ground or precipitated calcium carbonate, lime, calcium-magnesium carbonate, talcum, gypsum, graphite, barite, pyrogenic or precipitated silica, silicates, mica, wollastonite, kaolin, feldspar, chlorite, bentonite, montmorillonite, dolomite, quartz, cristobalite, calcium oxide, aluminum hydroxide, magnesium oxide, hollow ceramic spheres, hollow glass spheres, hollow organic spheres, glass spheres, functionalized alumoxanes, and carbon black. Preferred solid particulate fillers include both organically coated and also uncoated commercially available forms of the fillers included in the above presented list.

The at least one solid particulate filler F is preferably in the form of finely divided particles. The term “finely divided particles” refers to particles, whose median particle size d₅₀ does not exceed 500 μm, in particular, 250 μm. The term “median particle size d₅₀” refers in the present document to a particle size below which 50% of all particles by volume are smaller than the d₅₀ value. The particle size distribution can be determined by sieve analysis according to the method as described in ASTM C136/C136M-14 standard (“Standard Test Method for Sieve Analysis of Fine and Coarse Aggregates).

According to one or more embodiments, the at least one particulate filler F comprises at least one filler selected from the list consisting of ground or precipitated calcium carbonate, lime, calcium-magnesium carbonate, talcum, gypsum, graphite, barite, silica, silicates, mica, wollastonite, carbon black, and mixtures thereof.

According to one or more embodiments, the at least one particulate filler F comprises 10-50 wt.-%, preferably 15-45 wt.-%, more preferably 20-45 wt.-%, even more preferably 25-40 wt.-% of the total weight of the thermally expandable composition.

According to one or more embodiments, the thermally expandable composition further comprises at least one flame retardant FR.

Suitable flame retardants include, for example, melamine derivatives, phosphates, pyrophosphates, polyphosphates, organic and inorganic phosphinates, organic and inorganic phosphonates, and derivatives of the aforementioned compounds.

Preferred flame retardants include non-halogen phosphates and non-halogen polyphosphates, for example, trimethyl phosphate, triethyl phosphate, ethylenediamine phosphate, di-melamine orthophosphate, di-melamine pyrophosphate, triphenyl phosphate, trixylenyl phosphate, cresyl triphenyl phosphate, diphenylcresyl phosphate, piperazine phosphate, ammonium polyphosphate, ammonium polyphosphate particles coated with melamine, melamine polyphosphate, polyphosphates of 1,3,5-triazine compounds, and piperazine polyphosphate.

According to one or more embodiments, the at least one flame retardant FR comprises or consists of at least one non-halogen phosphate FR1, preferably selected from the group consisting of trimethyl phosphate, triethyl phosphate, ethylenediamine phosphate, triphenyl phosphate, trixylenyl phosphate, cresyl triphenyl phosphate, and diphenylcresyl phosphate.

According to one or more embodiments, the at least one flame retardant FR comprises or consists of at least one non-halogen polyphosphate FR2, preferably selected from the group consisting of ammonium polyphosphate, ammonium polyphosphate particles coated with melamine, melamine polyphosphate, polyphosphates of 1,3,5-triazine compounds, and piperazine polyphosphate.

According to one or more embodiments, the sum of the amount of the at least one flame retardant FR, if used, and the amount of the fibrous magnesium oxysulphate and the carbon fibers comprises 10-40 wt.-%, preferably 15-35 wt.-%, more preferably 15-30 wt.-% of the total weight of the thermally expandable composition.

According to one or more embodiments, the thermally expandable composition after curing has a volume increase compared to the uncured composition of not more than 500%, preferably not more than 400%, more preferably not more than 350%, whereby the volume increase is determined using the DIN EN ISO 1183 method of density measurement (Archimedes principle) in deionised water in combination with sample mass determined by a precision balance.

According to one or more embodiments, the thermally expandable composition after curing has a volume increase compared to the uncured composition in the range of 25-500%, preferably 50-400%, more preferably 75-350%, even more preferably 100-350%.

The preferences given above for the at least one solid rubber R, the at least one tackifying resin TR, the at least one blowing agent BA, the vulcanization system VS, the fibrous magnesium oxysulphate, the at least one plasticizer PL, the at least one filler F, and the at least one flame retardant FR apply equally for all subjects of the present invention unless stated otherwise.

The thermally expandable compositions according to the present invention can be produced by mixing the components in any suitable mixing apparatus, for example in a dispersion mixer, planetary mixer, double screw mixer, continuous mixer, extruder, or dual screw extruder.

Preferably, the at least one solid rubber R and the at least one plasticizer PL, if used, are mixed in a separate step using a kneader, preferably a sigma blade kneader until a homogenous mixture is obtained. This homogenous mixture is then preferably mixed with the remaining components of the thermally expandable composition in the suitable mixing apparatus mentioned above.

It may be advantageous to heat the components before or during mixing, either by applying external heat sources or by friction generated by the mixing process itself, in order to facilitate processing of the components into a homogeneous mixture by decreasing viscosities and/or melting of individual components.

However, care has to be taken, for example by temperature monitoring and use of cooling devices where appropriate, that the activation temperatures of the blowing agent BA and vulcanization system VS are not exceeded during the mixing process.

The thermally expandable compositions according to the present invention obtained by using the process as described above are storage stable at normal storage conditions. The term “storage stable” refers in the present disclosure to materials, which can be stored at specified storage conditions for long periods of time, such as at least one month, in particular at least 3 months, without any significant changes in the application properties of the material. The “typical storage conditions” refer here to temperatures of not more than 60° C., in particular not more than 50° C.

Another subject of the present invention is a shaped article comprising a substrate layer composed of the thermally expandable composition according to the present invention.

According to one or more embodiments, the substrate layer is a sheet-like element, preferably having a thickness in the range of 0.1-10 mm, preferably 0.25-5 mm, more preferably 0.35-3.5 mm, even more preferably 0.5-2.5 mm. The term sheet-like element refers in the present disclosure to elements having first and second major surfaces defining a thickness there between and having a length and width at least 5 times, preferably at least 10 times, more preferably at least 15 times greater than the thickness of the element.

According to one or more embodiments, the substrate layer has a thickness in the range of 0.1-5 mm, preferably 0.25-3.5 mm, more preferably 0.5-3.0 mm, even more preferably 0.75-2.5 and/or having a width in the range of 5-350 mm, preferably 5-250 mm, more preferably 10-200 mm, even more preferably 10-150 mm. Such shaped articles have been found particularly suitable for use as welding sealer tapes.

According to one or more embodiments, the shaped article further comprises a handling layer covering at least a portion, preferably substantially the whole area of the first and/or second major surface of the substrate layer. According to one or more embodiments, the handling layer is composed of a thermoplastic polymer composition having a softening point measured by Ring and Ball method conducted according to DIN EN 1238 standard of 45-200° C., preferably 55-160° C., more preferably 65-125° C.

Preferably, the outwardly facing surface of the handling layer on the side opposite to the side of the substrate layer is non-tacky at normal room temperature. Whether a surface of a specimen is tacky or not can be determined by pressing the surface with the thumb at a pressure of about 5 kg for 1 second and then trying to lift the specimen by raising the hand. In case the thumb does not remain adhered to the surface and the specimen cannot be raised up, the surface is considered to be non-tacky.

The shaped articles according to the present invention can be produced, for example, by injection moulding, punching or stamping, extrusion, calendering, or hot-pressing of the thermally expandable composition.

Another subject of the present invention is a method for providing sealing, structural adhesion, baffling, or combination thereof to a structure of a manufactured article, preferably an automotive vehicle, the method comprising steps of:

i) Providing a thermally expandable composition according to the present invention between a first member and a second member of the structure, both first and second members having outwardly and inwardly facing surfaces,

ii) Forming a weld connecting the first member to the second member such that at least a portion of the thermally expandable composition is displaced, and

iii) Activating the thermally expandable composition such that the composition cures and/or expands.

The weld connecting the first and second members can be formed using any suitable welding techniques, such as electrical resistance welding or spot welding.

According to one or more embodiments, step ii) comprises steps of:

i′) Contacting the outwardly facing surface of the first member with a first electrode and contacting the outwardly facing surface of the second member with a second electrode and

ii′) Inducing an electric current to flow between the first and second electrodes to form a weld connecting the first and second members.

Preferably, the first and second electrodes are contacted with the respective outwardly facing surfaces of the first and second members such that at least a portion of the first member and at least a portion of the second member are located between the electrodes.

In a typical weld operation, the electrodes and consequently the portions of the members are then moved towards each other, which results in partial displacement of the thermally expandable material. The electrodes can be moved until the portions of the members contact each other or until the distance between the portions is small enough for forming a weld. Electrical current is then induced between the electrodes, which results in formation of one or more welds between the first and second member. The resulting weld(s) is typically at least partially surrounded by the thermally expandable composition.

The thermally expandable material can be activated to cure and/or expand before, during, or after the welding operation. Preferably, the thermally expandable material is activated after the welding operation, i.e. after the step ii) of the method has been conducted. When the structure is part of an automotive vehicle, the activation of the thermally expandable material can be conducted during a paint or coating process, such as e-coating (curing) process.

According to one or more embodiments, the thermally expandable composition, upon activation, has a volume increase compared to its original unexpanded volume of 25-500%, preferably 50-400%, more preferably 75-350%, even more preferably 100-350%, whereby the volume increase is determined using the DIN EN ISO 1183 method of density measurement (Archimedes principle) in deionised water in combination with sample mass determined by a precision balance.

Still another subject of the present invention is a use of fibrous magnesium oxysulphate or carbon fibers or mixtures thereof in a thermally expandable composition to improve sag resistance and/or flame resistance properties of said composition.

According to one or more embodiments, the microcrystalline structure of the fibrous magnesium oxysulphate is a whisker.

According to one or more embodiments, the particles of the fibrous magnesium oxysulphate have an average aspect ratio of at least 5, preferably at least 10, more preferably at least 15, even more preferably at least 20 and/or an average particle diameter of not more than 10 μm, preferably not more than 5 μm, more preferably not more than 3.5 μm, even more preferably not more than 3.0 μm, such as not more than 2.5 μm and/or an average particle length of not more than 100 μm, preferably not more than 75 μm, more preferably not more than 50 μm, even more preferably not more than 40 μm, such as not more than 35 μm.

The carbon fibers that can be used instead or in addition to the fibrous magnesium oxysulphate, are preferably milled carbon fibers. According to one or more embodiments, the carbon fibers have an average fiber diameter of not more than 50 μm, preferably not more than 35 μm, more preferably not more than 25 μm, even more preferably not more than 20 μm, most preferably not more than 15 μm and/or an average fiber length of not more than 500 μm, preferably not more than 350 μm, more preferably not more than 250 μm, even more preferably not more than 200 μm, such as not more than 150 μm.

According to one or more embodiments, the carbon fibers have an average fiber diameter in the range of 1-50 μm, preferably 2.5-35 μm, more preferably 2.5-25 μm, even more preferably 3.5-15 μm and/or an average particle length in the range of 15-500 μm, preferably 25-350 μm, more preferably 25-250 μm, even more preferably 50-150 μm.

According to one or more embodiments, the fibrous magnesium oxysulphate or carbon fibers or a mixture thereof are present in the thermally expandable composition in an amount of 1-30 wt.-%, preferably 5-25 wt.-%, more preferably 7.5-25 wt.-%, even more preferably 10-25 wt.-%, still more preferably 10-20 wt.-%, most preferably 10-17.5 wt.-%, based on the total weight of the thermally expandable composition.

According to one or more embodiments, the thermally expandable composition comprises at least one solid rubber, at least one tackifying resin, at least one blowing agent, and a vulcanization system, preferably the at least one solid rubber R, the at least one tackifying resin TR, the at least one blowing agent BA, and the vulcanization system VS as discussed above.

According to one or more embodiments, the at least one solid rubber comprises 5-35 wt.-%, preferably 7.5-30 wt.-%, more preferably 10-25 wt.-%, even more preferably 12.5-20 wt.-% of the total weight of the thermally expandable composition.

### Examples

The following chemicals shown in Table 1 were used in formulating the thermally expandable compositions.

TABLE 1

| | |
|---|---|
| SBR | SB-rubber, Mooney viscosity 45-60 MU (ML |
| | (1 + 4) 100° C.), styrene content 23 wt.-% |
| BR | Butyl rubber, Mooney viscosity 41 MU (ML |
| | (1 + 4) 100° C.) |
| Tackifier | C5 aliphatic hydrocarbon resin, softening |
| | point 90-110° C. (ASTM E 28) |
| Blowing agent | Azodicarbonamide |
| Activator | Urea |
| Curing agent | Tetramethyl thiuram disulfide (TMTD) |
| Accelerator1 | Zinc oxide |
| Accelerator2 | Mercaptobenzothiazole sulfide (MBTS) |
| Fibrous Mg oxysulphate | 5Mg(OH)₂•MgSO₄•3H₂O (whisker), mean |
| | fiber length 15 μm, mean fiber diameter 0.5 |
| | μm |
| Carbon fibers | Fiber diameter 7.2 μm, average fiber length |
| | 100 μm, density 1.8 g/cm³ |
| Plasticizer | Naphtenic oil |
| Filler | Calcium carbonate |
| Flame retardant | Triphenyl phosphate (TPP) |

Preparation of the Thermally Expandable Compositions

All inventive (Ex-1 to Ex-3) and non-inventive (Ref-1) formulations having the compositions as shown in Table 2 were prepared according to the following procedure.

In a first step, the solid rubbers SBR and BR were mixed in a sigma blade kneader for 15 min. After that, the plasticizer was added constantly over a time of 5 hours. After this, the obtained mixture and all the remaining components were added into a speed mixer (total weight of the final composition approximately 300 g) and mixed during 3 min. The mixed compositions were then stored in sealed cartridges.

Needle Penetration

The needle penetration depths were measured by using the method as defined in ASTM D5 standard at a temperature of 23° C. and using a weight of 150 g.

Volume Expansion

The tested formulations were first shaped into form of strips having dimensions 25×25×2 mm (length×width×thickness) and then baked at 160° C. for 20 minutes. The volume expansion in percentage was then calculated as: (V_{after}−V_{before})/V_{before}. The volumes of the strips before and after the baking process were determined based on density measurements. The densities of the strips were measured according to DIN EN ISO 1183 standard using the water immersion method (Archimedes principle) in deionized water and a precision balance to measure the mass.

Sag Resistance

A strip of the tested formulation having dimensions of 200×20×2 mm (length×width×thickness) was adhered on a CRS (cold rolled steel) plate and the thus obtained specimen was positioned vertically in a baking oven. The maximum vertical distance in millimeters that the lower edge of the strip had “dropped” during baking at 160° C. for 20 minutes was measured and recorded as the occurred “sag”.

Flame Resistance

A ribbon of the tested formulation having dimensions of 10 mm×20 mm×2 mm (width×length×thickness) was first adhered on a CRS (cold rolled steel) plate. The surface of the strip was then contacted with a flame for 10 seconds after which the test specimen was removed from the flame and the burn behavior was observed. The values presented in Table 2 represent the length of burning after the test specimen was removed from the flame. In case no burning was observed, the result is indicated as “no flame”.

TABLE 2

| | Ref-1 | Ex-1 | Ex-2 | Ex-3 | Ex-4 | Ex-5 |
|---|---|---|---|---|---|---|
| Composition [wt.-%] | | | | | | |
| SBR | 16 | 16 | 16 | 16 | 16 | 16 |
| BR | 1 | 1 | 1 | 1 | 1 | 1 |
| Tackifier | 10 | 10 | 10 | 10 | 10 | 10 |
| Blowing agent | 1.5 | 1.5 | 1.5 | 1.5 | 1.5 | 1.5 |
| Activator | 1.5 | 1.5 | 1.5 | 1.5 | 1.5 | 1.5 |
| Curing agent | 2 | 2 | 2 | 2 | 2 | 2 |
| Accelerator1 | 2 | 2 | 2 | 2 | 2 | 2 |
| Accelerator2 | 3 | 3 | 3 | 3 | 3 | 3 |
| Fibrous Mg oxysulphate | — | 10 | 15 | 20 | — | — |
| Carbon fibers | — | — | — | — | 10 | 20 |
| Plasticizer | 10 | 10 | 10 | 10 | 10 | 10 |
| Filler | 33 | 33 | 33 | 33 | 33 | 33 |
| Flame retardant | 20 | 10 | 5 | — | 10 | — |
| Measured properties | | | | | | |
| Processability | −−− | +++ | ++ | + | ++ | + |
| Penetration depth [mm] | ND | 7.4 | 6.7 | 4.7 | 8.1 | 4.8 |
| Volume expansion [%] | ND | 254 | 173 | 127 | 386 | 143 |
| Sag resistance [mm] | ND | 2 | 0 | 0 | 4 | 0 |
| Flame resistance | ND | No flame | <20 s | >30 s | No flame | >30 s |

1. A thermally expandable composition comprising:
a) at least one solid rubber R,
b) at least one tackifying resin TR,
c) at least one blowing agent BA,
d) a vulcanization system VS, and
e) 1-30 wt. %, based on the total weight of the thermally expandable composition, of fibrous magnesium oxysulphate, carbon fibers, or a mixture thereof.

2. The thermally expandable composition according to claim 1, wherein the fibrous magnesium oxysulphate comprises 5Mg(OH)₂.MgSO₄.3H₂O and/or wherein the microcrystalline structure of the fibrous magnesium oxysulphate is a whisker.

3. The thermally expandable composition according to claim 1, wherein the particles of the fibrous magnesium oxysulphate have an average aspect ratio of at least 5, and/or an average particle diameter of not more than 10 μm, and/or an average particle length of not more than 100 μm.

4. The thermally expandable composition according to claim 1, wherein the at least one solid rubber R comprises 5-35 wt.-%, of the total weight of the thermally expandable composition.

5. The thermally expandable composition according to claim 1, wherein the at least one solid rubber R is selected from the group consisting of butyl rubber, halogenated butyl rubber, styrene-butadiene rubber (SBR), ethylene-propylene rubber (EPR), ethylene-propylene diene monomer rubber (EPDM), natural rubber, cis-1,4-polyisoprene, and polybutadiene rubber.

6. The thermally expandable composition according to claim 1, wherein the at least one tackifying resin TR comprises 2.5-30 wt. % of the total weight of the thermally expandable composition.

7. The thermally expandable composition according to claim 1, wherein the at least one blowing agent BA comprises 0.1-5 wt. % of the total weight of the thermally expandable composition.

8. The thermally expandable composition according to claim 1, wherein the vulcanization system VS is a vulcanization system without elementary sulfur, and further containing at least one organic vulcanization accelerator and/or at least one inorganic vulcanization accelerator.

9. The thermally expandable composition according to claim 1, wherein the vulcanization system VS comprises 1-15 wt. % of the total weight of the thermally expandable composition.

10. The thermally expandable composition according to claim 1 further comprising at least one plasticizer PL.

11. The thermally expandable composition according to claim 10, wherein the at least one plasticizer PL is present in the thermally expandable composition in an amount of 2.5-25 wt. %, based on the total weight of the thermally expandable composition.

12. The thermally expandable composition according to claim 1 further comprising at least one particulate filler F selected from the group consisting of ground or precipitated calcium carbonate, lime, calcium-magnesium carbonate, talcum, gypsum, graphite, barite, pyrogenic or precipitated silica, silicates, mica, wollastonite, kaolin, feldspar, chlorite, bentonite, montmorillonite, dolomite, quartz, cristobalite, calcium oxide, aluminum hydroxide, magnesium oxide, hollow ceramic spheres, hollow glass spheres, hollow organic spheres, glass spheres, functionalized alumoxanes, and carbon black and wherein the at least one particulate filler F comprises 10-50 wt. % of the total weight of the thermally expandable composition.

13. The thermally expandable composition according to claim 12, wherein the at least one particulate filler F comprises at least one filler selected from the group consisting of ground or precipitated calcium carbonate, lime, calcium-magnesium carbonate, talcum, gypsum, graphite, barite, silica, silicates, mica, wollastonite, carbon black.

14. A shaped article comprising a substrate layer composed of the thermally expandable composition according to claim 1.

15. A method for providing sealing, structural adhesion, baffling, or combination thereof to a structure of a manufactured article, the method comprising steps of:
i) providing a thermally expandable composition according to claim 1 between a first member and a second member of the structure, both first and second members having outwardly and inwardly facing surfaces,
ii) forming a weld connecting the first member to the second member such that at least a portion of the thermally expandable composition is displaced, and
iii) activating the thermally expandable composition such that the composition cures and/or expands.

16. The method according to claim 15, wherein step ii) comprises steps of:
i′) contacting the outwardly facing surface of the first member with a first electrode and contacting the outwardly facing surface of the second member with a second electrode and
ii′) inducing an electric current to flow between the first and second electrodes to form a weld connecting the first and second members.

17. A thermally expandable composition that comprises at least one solid rubber, at least one tackifying resin, at least one blowing agent, and a vulcanization system, and further includes at least one of fibrous magnesium oxysulphate and carbon fibers in sufficient amounts to improve the sag resistance and/or flame resistance properties of the thermally expandable composition.

18. The thermally expandable composition according to claim 17, wherein the at least one fibrous magnesium oxysulphate and carbon fibers is present in the thermally expandable composition in an amount of 1-30 wt. %, based on the total weight of the thermally expandable composition.
